(19) United States
(12) Patent Application Publication
(10) Pub. No.: US 2013/0008065 A1
(43) Pub. Date: Jan. 10, 2013

(54) Adjustable Sign Holder

(75) Inventor: Scott Danielson, Rockford, IL (US)

(73) Assignee: SOUTHERN IMPERIAL, INC., Rockford, IL (US)

(21) Appl. No.: 13/177,181

(22) Filed: Jul. 6, 2011

(51) Int. Cl. G09F 15/00

(52) U.S. Cl. 40/606.01

(57) ABSTRACT

A sign holder is provided. The sign holder is adjustable for attachment to display apparatuses of various sizes, dimensions, and configurations. The sign holder includes a main body structure portion, a first mounting leg, and a second mounting leg detachable from the main body structure and adjustable relative to the first mounting leg.

### FIELD OF THE INVENTION

This invention generally relates to the field of retail displays, and more particularly to sign holders for retail displays.

### BACKGROUND OF THE INVENTION

In retail or other sales environments, products for sale may be disposed on, under, or around shelf units of various sizes, thicknesses, and configurations, or other suitable display apparatus. Sign holders are used to hold signage displaying indicia, including, for example, price, product information, manufacturer information, regarding the product to be sold.

In the past different sign holders of various sizes and configurations would be provided for each of the different shelf units or other display apparatuses for holding signs displaying indicia regarding the products to be sold. This meant that an inventory of different size sign holders would need to be kept on hand to accommodate the display on the different shelf units or other display apparatuses, which different size sign holders are costly to purchase and to maintain on hand, many of which will not be in use at any given moment. With the proliferation of display apparatuses and shelf units, additional traditional sign holders would need to be purchased and inventoried, in some cases with previously used and inventoried sign holders going to waste. Additionally, with traditional sign holders, if for some reason a sign holder of the proper dimension for a particular display apparatus or shelving unit is unavailable or not in inventory, other sign holders may not be able to be substituted.

Various embodiments of the present invention overcome various disadvantages and limitations of the prior art.

### BRIEF SUMMARY OF THE INVENTION

In one aspect, embodiments of the invention provide a sign holder. The sign holder includes a main body structure including a sign receiving structure. The main body structure also includes a plurality of second mounting leg receiving structures. The sign holder also includes a first mounting leg. The first mounting leg extends from the main body structure portion. The sign holder also includes a second mounting leg. The second mounting leg is selectively removable from the main body structure.

In one embodiment, the first mounting leg includes a display apparatus engagement portion. The display apparatus engagement portion of the first mounting leg forms an acute angle with the main body structure when the sign holder is not engaged with a display apparatus. In one embodiment, the second mounting leg includes a display apparatus engagement portion and a main body structure engagement portion. The main body structure engagement portion is selectively mountable to each of the plurality of second mounting leg receiving structures. Each of the second mounting leg receiving structures locates the display apparatus engagement portion of the second mounting leg a different distance from the display apparatus engagement portion of the first mounting leg.

In one embodiment, at least one of the display apparatus engagement portion of the first mounting leg and the display apparatus engagement portion of the second mounting leg includes at least one flexible finger formed of a different material than the other portions of the first and second mounting legs and displaceable towards the one of the display apparatus engagement portion of the first mounting leg and the second mounting leg to accommodate display apparatuses of various sizes.

In one embodiment, the display apparatus engagement portions of the first and second mounting legs are configured to flex away from one another when engaging a display apparatus and to increase the angle between the first mounting leg and the main body structure and the angle between the second mounting leg and the main body structure.

In one embodiment, the second mounting leg is formed with the main body structure as a single unitary piece. In one embodiment, the sign holder is constructed as at least one of co-extruded polyvinylcholoride, butryrate, provista, and acrylonitrile butadiene styrene.

In one embodiment, the sign receiving structure comprises a channel with at least one flexible finger extending into the channel. In one embodiment, when the second mounting leg is engaged with one of the second mounting leg receiving structures and the sign holder is mounted on a display apparatus, the second mounting leg contacts the main body structure proximate the one of the second mounting leg receiving structures to bias the second mounting leg to hold against the display apparatus.

In another aspect, embodiments of the present invention provide a sign holder. The sign holder includes a main body structure. The sign holder also includes a flexible first mounting leg having a base and a distal end portion extending from the base, the base extending from the main body structure. The sign holder also includes a flexible second mounting leg. The second mounting leg has a main body structure engagement portion and a distal end portion extending from the main body structure engagement portion. The main body structure engagement portion is positionable at various locations on the main body structure relative to the first mounting leg. The first mounting leg, the second mounting leg, and the main body structure form a display apparatus receiving channel. The channel is configured to receive various display apparatuses. A dimension of the display apparatus receiving channel is variable based on the position of the base of the first mounting leg. The distal end portions of the first and second mounting legs are displaceable relative to one another to vary the size of the display apparatus receiving channel to receive display apparatuses of different dimensions.

In one embodiment, the main body structure, the first mounting leg, and the second mounting leg are extruded as a single, unitary piece with the second mounting leg being detachable therefrom. In one embodiment, the main body structure further comprises a first second mounting leg receiving structure spaced apart a first distance from the first mounting leg and a second second mounting leg receiving structure spaced apart a second distance from the first mounting leg. The second mounting leg is selectively engageable with each of the mounting leg receiving structures to selectively vary the distance between the second mounting leg and the first mounting leg and a dimension of the display apparatus receiving channel.

In one embodiment, the second mounting leg receiving structures each include a mounting post. The second mounting leg includes a channel. The mounting post is received in the channel to selectively releasably couple the second mounting leg to the main body structure. In one embodiment, the second mounting leg receiving structures each define a channel. The second mounting leg includes a projection. The projection is received in the channel to selectively releaseably couple the second mounting leg to the main body structure.

In one embodiment, the main body structure includes a sign receiving channel to support signs of various dimensions. In one embodiment, the first and second mounting legs are resiliently biased toward one another. The first mounting leg is configured to exert a force on a first surface of a display apparatus. The second mounting leg is configured to exert a force on a second surface of a display apparatus. The display apparatus is thereby pinched between the first and second mounting legs, mounting the main body structure to a display apparatus.

In one aspect, embodiments of the invention provide a sign holder. The sign holder includes a main body structure. The main body structure includes a plurality of mounting structures. The sign holder also includes a flexible first mounting leg extending outwardly from the main body structure. The sign holder also includes a second mounting leg selectively mountable with the main body structure on a select one of the plurality of mounting structures. The main body structure, the first mounting leg, and second mounting leg define a variable width channel. A width of the variable width channel is set by the distance between the first and second mounting legs when the second mounting leg is mounted on the select one of the plurality of legs.

In one embodiment, the main body structure, the first mounting leg, and the second mounting leg are extruded as a single unitary piece. The second mounting leg is selectively detachable from the single, unitary piece.

In one aspect, embodiments of the invention provide a display apparatus. A display apparatus includes a shelf having a front surface, a top surface and a bottom surface. The display apparatus also includes a sign holder including a main body structure, a first leg, and a second leg, together defining a shelf receiving channel. The second leg is repositionable relative to the first leg in the main body structure, thereby adjusting the size of the shelf receiving channel to accommodate the shelf. The first leg is biased against one of the top surface and the bottom surface of the shelf. The second leg is biased against the other of the top surface and the bottom surface of the shelf, thereby holding the sign holder to the shelf. The main body structure includes a sign supporting structure.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective exploded view of an embodiment of a sign holder of the present invention;

FIG. 2 is a detailed side view of a mounting post and a portion of a mounting leg of the sign holder of FIG. 1;

FIG. 3 is an assembled side view of a portion of the sign holder of FIGS. 1 and 2;

FIG. 4 is a perspective view of the sign holder of FIGS. 1-3 with the second mounting leg mounted in a different configuration to the main body structure;

FIG. 5 is a detailed side view of a portion of the sign holder of FIGS. 1-4 receiving an exemplary sign;

FIG. 6 is a side view of the sign holder of FIGS. 1-5 engaged with an exemplary display apparatus;

FIG. 7 is a perspective view of an embodiment of a sign holder of the present invention formed as a single extrusion;

FIG. 8 is a perspective view of a second embodiment of a sign holder of the present invention;

FIG. 9 is a side view of the sign holder of FIG. 8;

FIG. 10 is a detailed view of the portion of the sign holder of FIGS. 8 and 9 indicated in FIG. 9;

FIG. 11 is a perspective view of a third embodiment of a sign holder of the present invention; and

FIG. 12 is a side view of the sign holder of FIG. 11.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

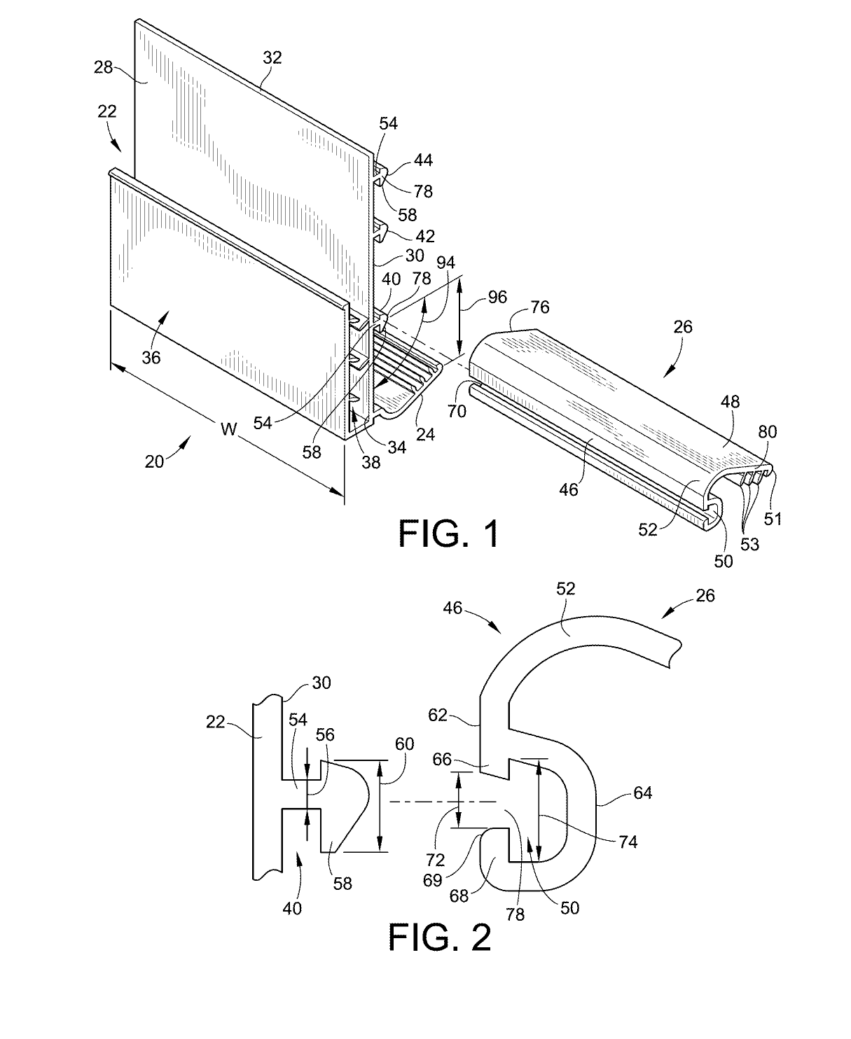

With reference to FIG. 1, a sign holder 20 is provided. In one embodiment, the sign holder 20 is adapted to be adjustable so that it can mount on shelves or other display apparatuses of various sizes and thicknesses. The sign holder 20 is configured to be adjusted in moderate size increments, but also includes features which will allow for attachment to shelves, for example, the size of which fall between the moderate size increments. Thus, flexibility and adaptability are provided.

Additionally, the sign holder 20 provides a sign mounting portion that allows for both easy mounting and removal of signage of various thickness and configuration while allowing for secure holding of the signage while mounted. Finally, the sign holder 20 may be formed by extrusion as a single piece in one embodiment, thus reducing the need for time-consuming sorting of pieces for packaging and providing the sign holder 20 in a single piece to consumers.

With further reference to FIG. 1, in one embodiment of the present invention, the sign holder 20 is adjustable allowing the sign holder 20 to be attached to shelving or other product display apparatus of various sizes, thicknesses, and configurations. The sign holder 20 includes a main body structure 22 and a first mounting leg 24 extending from the main body structure 22. The sign holder 20 also includes a removable second mounting leg 26, thus facilitating the adjustability features described herein.

The main body structure 22, the first mounting leg 24, and the second mounting leg 26 together form a mounting channel, as will be explained further below. Also as will be further explained below, the second mounting leg 26 is mountable at various locations on the main body structure 20 various distances from the first mounting leg 24. By varying the mounting location of the second mounting leg 26 relative to the first mounting leg 24, the size of the mounting channel may be adapted to allow for mounting of the sign holder 20 on various shelves and other display apparatuses.

With further reference to FIG. 1, in one embodiment the main body structure 22 includes a front side 28 and a rear side 30 and extends vertically from a first end 32 to a second end 34 and horizontally over a width W. Extending from the front side 28 of the main body structure 22 proximate the second end 34 is a sign receiving structure 36, which, together with the front side 28 of the main body structure 22 defines a U-shaped sign channel 38.

As is illustrated in FIG. 1, the first mounting leg 24 extends from the rear side 30 of the main body structure 22 proximate the second end 34. Also extending from the rear side 30 of the main body structure 22 are a plurality of second mounting leg receiving structures, shown in the illustrated embodiment as mounting posts 40, 42, 44. In FIG. 1 the mounting posts 40, 42, 44 are illustrated, however, greater or fewer mounting posts are also envisioned, and may be spaced various distances apart, including consistent and/or varied distances. The mounting posts 40, 42, 44 are spaced apart between the first end 32 and second end 34 of the rear side 30 of the main body structure 22.

With further reference to FIG. 1, and as will be explained further below, the second mounting leg 26 includes a mounting post engagement portion 46 and a display apparatus engagement portion such as a shelf engagement portion 48. In one embodiment, the mounting post engagement portion 46 defines a generally C-shaped channel 50 which receives a mounting post 40, 42, 44 to selectively couple the second mounting leg 26 to the main body structure 22. The second mounting leg 26 also includes a curved portion 52 extending between the mounting post engagement portion 46 and the shelf engagement portion 48.

As will be explained further below, the curved portion 52 is configured such that the shelf engagement portion 48 extends at an acute angle relative to the mounting post engagement portion 46 when the shelf engagement portion 48 is not engaged with a shelf or other display apparatus. In one embodiment the curved portion 52 is resilient and biases the shelf engagement portion 48 towards the acute angle forming position. The shelf engagement portion 48 includes a downwardly extending corner 51 proximate the portion of the shelf engagement portion 48 distal from the curved portion 52. Between the downwardly extending corner 51 and the curved portion 52, the shelf engagement portion 48 also includes a plurality of downwardly extending flexibly resilient fingers 53. The fingers 53 may be soft vinyl fingers or may be formed from any other suitable material known in the art.

With reference to FIG. 2, the mounting posts 40, 42, 44 will be described in greater detail. For concision, only mounting post 40 is described in detail with mounting posts 42 and 44 being substantially similar. The mounting post 40 includes a projection 54 projecting from the rear side 30 of the main body structure 22. The projection 54 may extend substantially along all of or a portion of the width W of the main body structure 22. The projection 54 is of thickness 56. Extending from projection 54 is a crossbar portion 58. The crossbar portion 58 has a thickness 60 proximate the projection 54, with the height 60 of the crossbar portion 58 being greater than the thickness 56 of the projection 54. The crossbar portion 58 tapers away from the projection 54 with the thickness of the crossbar portion 58 being greatest proximate the projection 54.

As is further illustrated by FIG. 2, the mounting post engagement portion 46 of the second mounting leg 26 includes a vertical wall 62 extending from the curved portion 52. The generally C-shaped channel 50 is defined by a generally C-shaped wall 64, the top portion of which extends from the vertical wall 62. The vertical wall 62 includes a top overhanging portion 66 extending past the junction between the top portion of the C-shaped wall 64 and the vertical wall 62. The top overhanging portion 66 may be beveled proximate the entrance to the channel 50. The mounting post engagement portion 46 also includes a bottom overhanging portion 68 extending from the C-shaped wall 64 distal from the junction of the C-shaped wall 64 and the vertical wall 62. The bottom overhanging portion 68 extends upwardly towards the top overhanging portion 66 and has a curved edge 69 proximate a gap 70 of height 72 between the top and bottom overhanging portions 66, 68. The C-shaped wall 64 defines an interior height 74 of the C-shaped channel 50 proximate the overhanging portions 66, 68 with the width of the C-shaped channel 50 tapering away from the gap 70 and the overhanging portions 66, 68.

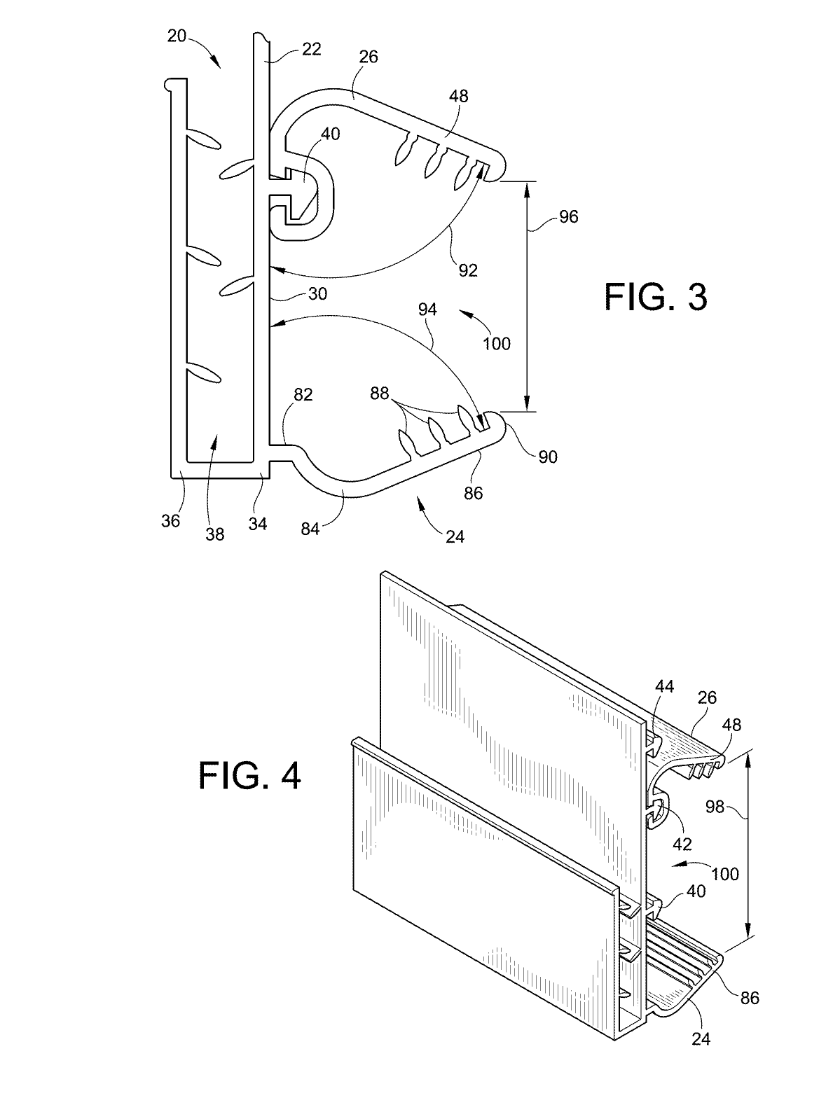

When the second mounting leg 26 is engaged with the mounting post 40, as may be seen in FIGS. 3-6 and is explained with reference to FIG. 2, the crossbar portion 58 of the second mounting leg 26 is contained within the C-shaped channel 50. The height 60 of the crossbar portion 58 is approximately the same dimension or smaller than the interior height 74 of the C-shaped wall 64 proximate the overhanging portions 66, 68, but the height 60 of the crossbar portion 58 is greater than the height 72 of the gap 70. The height 72 of the gap 70 is the same or greater than thickness 56 of the projection 54. Thus, the second mounting leg 26 is secured to the main body structure 22, with the mounting post 40 being slidingly displaceable within the C-shaped channel 50 allowing relative sliding displacement parallel to width W (see FIG. 1) between the second mounting leg 26 and the main body structure 22. However, once mounted, the second mounting leg 26 is not readily removable from the mounting body structure 22 in a direction perpendicular to width W without a sufficient application orifice.

In one embodiment, the second mounting leg 26 may be mounted in two ways. First, as illustrated in FIG. 1, a first end 76 of the second mounting leg 26 may be aligned with the first end 78 of the mounting post 40 such that the projection 54 is aligned with the gap 70 and the crossbar portion 58 is aligned with the C-shaped channel 50. The first end 76 of the second mounting leg 26 is displaced towards the first end 78 of the mounting post 40 such that the crossbar portion 58 is slidingly displaced into and along the C-shaped channel 50 and the projection is slidingly displaced within the gap 70.

The second mounting leg 26 may also be mounted in a second way. The first end 76 of the second mounting leg 26 may be located proximate the second end (opposite the first end 78) of the mounting post 40 and the second end 80 of the second mounting leg 26 located proximate the first end 78 of the mounting post 40. The C-shaped wall 64 is resiliently flexible. Thus, when the second mounting leg 26 is forced towards the mounting post 40, the crossbar portion 58 enters the gap 70 and forces the overhanging portions 66, 68 away from one another, increasing the height of the gap 70 until the crossbar portion 58 is within the C-shaped channel 50, at which point the overhanging portions 66, 68 are allowed to return towards one another and the gap 70 is reduced to its standard height 72 with the projection 54 located in the gap 70 and the second mounting leg 26 secured to the main body structure 22. The beveled edge of the top overhanging portion 66 and the curved edge 69 of the bottom overhanging portion 68 together with the shape of the crossbar portion 58 of the mounting posts 40, 42, 44 may also allow the crossbar portion 58 to more easily enter the channel 50.

In other embodiments, there may be various numbers of mounting posts spaced various distances apart and various distances from the first mounting leg 24. Additionally, in other embodiments, the mounting posts need not be identical or substantially similar.

With reference to FIG. 3, the first mounting leg 24 extends from the rear side 30 of the main body structure 22 proximate the second end 34 of the main body structure 22. The first mounting leg 24 extends generally opposite the sign receiving structure 36. The first mounting leg 24 includes a flange 82 extending away from the main body structure 22 to a curved portion 84 which extends from the flange 82 to a shelf engagement portion 86. The shelf engagement portion 86 includes a plurality of upwardly facing, flexibly resilient fingers 88 and an upwardly extending corner 90. The fingers 88 may be soft vinyl fingers or may be formed from any suitable material known in the art.

As is illustrated in FIG. 3, when the second mounting leg 26 is engaged with the first mounting post 40 and the sign holder 20 is not mounted on, for example, a shelf, the shelf engagement portion 48 of the second mounting leg 26 forms an acute angle 92 with the main body structure 22. When the sign holder 20 is not mounted on, for example, a shelf, the shelf engagement portion 86 of the first mounting leg 24 forms an acute angle 94 with the main body structure 22. The acute angles 92 and 94 may be the same or different angles.

When the second mounting leg 26 is mounted to the mounting post 40, as in FIG. 3, there is a distance 96 between the shelf engagement portion 48 of the second mounting leg 26 and the shelf engagement portion 86 of the first mounting leg 24. When the second mounting leg 26 is mounted to the mounting post 42, as in FIG. 4, there is a distance 98 between the shelf engagement portion 48 of the second mounting leg 26 and the shelf engagement portion 86 of the first mounting leg 24. As can be seen from FIGS. 3 and 4, the distance 98 is greater than the distance 96. Thus, the distance between the mounting legs 24 and 26 can be varied based on the mounting post 40, 42, 44 to which the second mounting leg 26 is coupled.

Returning to FIG. 3, the first mounting leg 24, the second mounting leg 26, and the main body structure 22 together form a display apparatus receiving channel, such as a shelf receiving channel 100 into which a display apparatus such as a shelf may be received. By mounting the second mounting leg 26 to various ones of the mounting posts 40, 42, 44, a user may vary the dimensions of the shelf receiving channel 100 allowing shelves and display apparatuses of various sizes and dimensions to be received into the shelf receiving channel 100 and allowing the sign holder 20 to be attached to various different shelves and display apparatuses of various different thicknesses, shapes, etc.

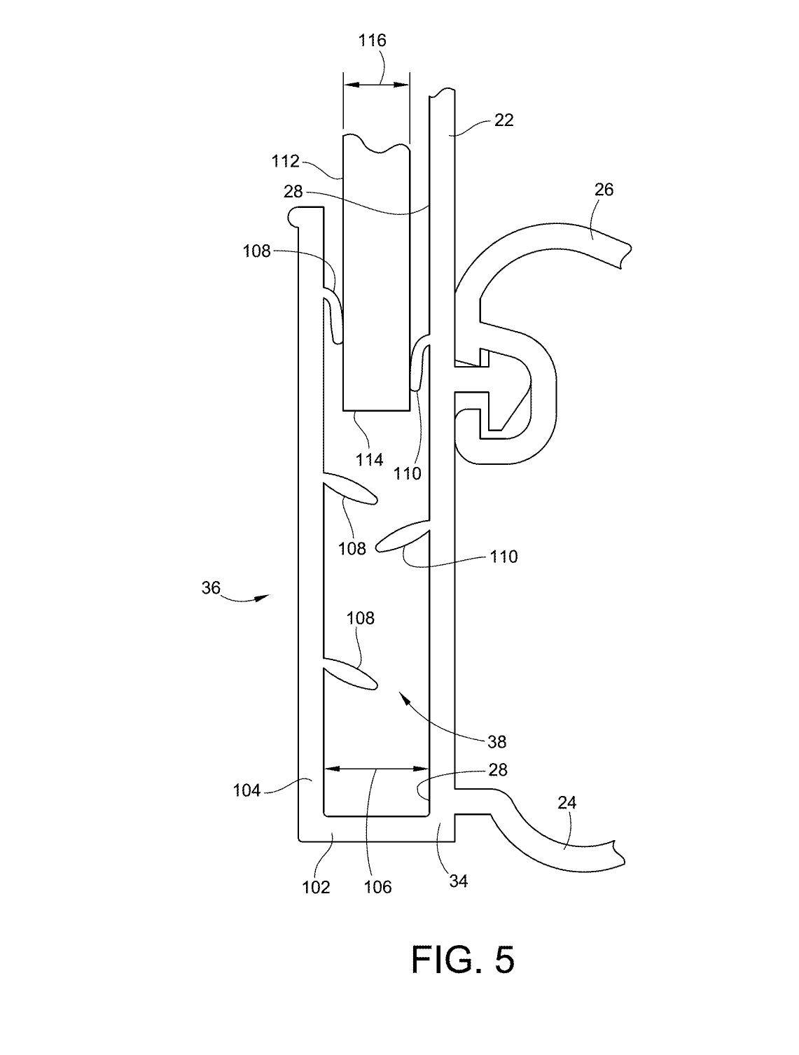

With reference to FIG. 5, the sign receiving structure 36 includes a flange 102 extending from the front side 28 of the main body structure 22 proximate the second end 34. Extending from the flange 102 distal from the main body structure 22 is a generally vertical wall 104. The flange 102, vertical wall 104, and front side 28 of the main body structure define the generally U-shaped sign channel 38, which has a width 106. The interior face of the vertical wall 104 facing the main body structure 22 includes a plurality of fingers 108 extending into the U-shaped sign channel 38. The front side 28 of the main body structure 22 also includes a plurality of fingers 110 extending into the U-shaped sign channel 38 offset relative to the fingers 108. The fingers 108, 110 may be soft vinyl fingers or may be formed from any suitable material known in the art.

As illustrated in FIG. 5, the U-shaped sign channel 38 is configured to receive a sign 112 which may include a variety of indicia related to a product to be displayed on a display apparatus. A leading edge 114 of the sign 112 is slidingly displaced into the U-shaped sign channel 38. As the sign 112 enters the sign channel 38 it displaces the ends of the fingers 108 and 110 downwardly towards the flange 102. Once the sign 112 is positioned within the U-shaped sign channel 38, the resilient fingers 108 and 110, which are resiliently flexible and thus are urged towards their initial configuration, press against each side of the sign 112, therefore tending to maintain the sign 112 in place within the U-shaped sign channel 38 pinching the sign between them. The sign 112 is of a width 116, with the width 116 being less than the width 106 of the U-shaped sign channel 38. Suitable signs may be of any width the same or less than the width 106 of the sign channel 38. The fingers 108, 110 serve, by resiliently urging themselves back to their original configuration, to tend to maintain signs of various widths smaller than the width 106 of the U-shaped sign channel 38 in place within the U-shaped sign channel 38, pinching these signs to secure them despite the difference between their width and the width 106 of the U-shaped channel 38.

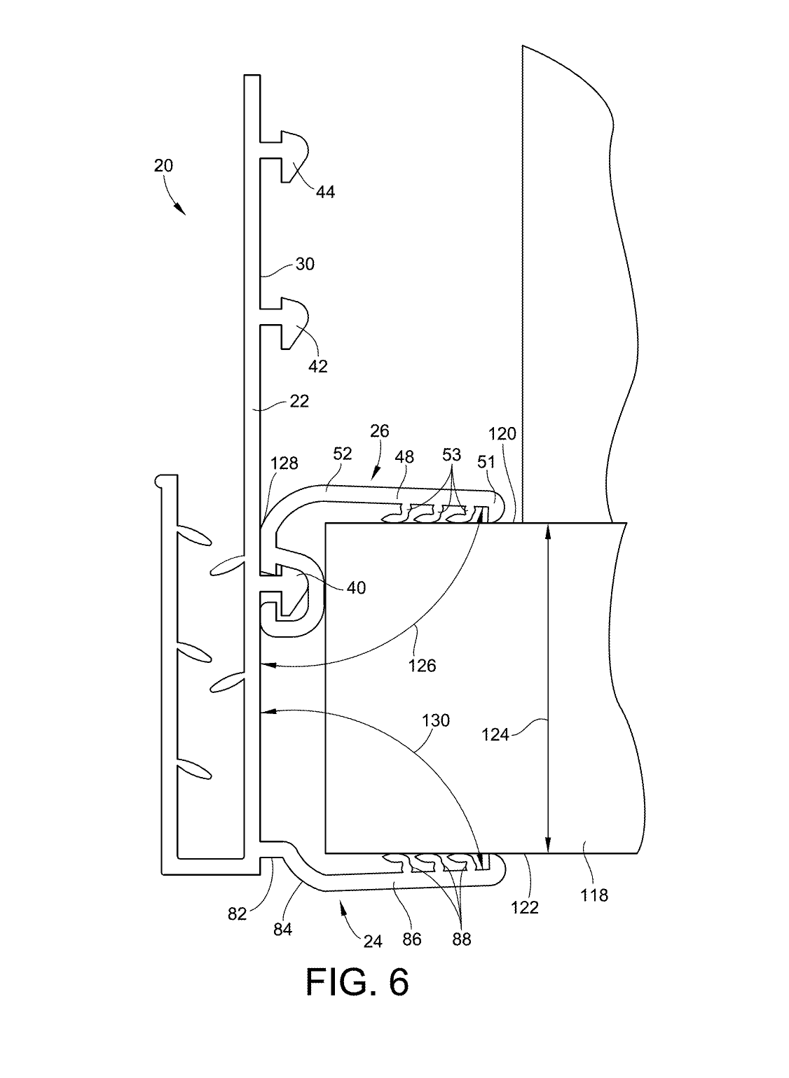

With reference to FIG. 6, the sign holder 20 is illustrated engaged with a shelf 118. The shelf 118 includes a top surface 120 and a bottom surface 122 and defines a thickness 124 between the top surface 120 and the bottom surface 122.

The thickness 124 is greater than the distance 98 between the shelf engagement portion 48 of the second mounting leg 26 and the shelf engagement portion 86 of the first mounting leg 24 when the sign holder 20 is not engaged with a display apparatus, as illustrated in FIG. 3. Returning to FIG. 6, the second mounting leg 26 is resiliently flexible and thus flexes outwardly to accommodate the shelf 118. The angle 126 formed between the shelf engagement portion 48 of the second mounting leg 26 and the main body structure 22 is greater than the angle 92, illustrated in FIG. 3, formed between the shelf engagement portion 48 of the second mounting leg 26 and the main body structure 22 when the sign holder 20 is not engaged with a display apparatus. The angle 126 will vary depending on the specific dimensions of the shelf 118, i.e., how much the second mounting leg 26 must be flexed to accommodate the shelf 118. Various angles and degrees of flexion of the second mounting leg 26 are envisioned.

Returning again to FIG. 6, the fingers 53 of the second mounting leg 26 contact the top surface 120 of the shelf 118 and tend to flex inwardly towards the main body structure 22. The fingers 53 can be formed from any suitable material known in the art, including, for example, soft vinyl, and provide contact and grip with the top surface 120, as well as accommodate surface variations in the top surface 120.

As the second mounting leg 26 flexes to accommodate the shelf 118, the second mounting leg 26 will contact the rear side 30 of the main body structure 22 at a point of contact 128. This point of contact 128 will serve as a fulcrum point for the second mounting leg 26 to create spring back pressure against the top surface 120 of the shelf 118 allowing the second mounting leg 26 to hold against the top surface 120. The flexibly resilient nature of the second mounting leg 26 may also urge the second mounting leg 26 towards the top surface 120 of the shelf 118 to create pressure against the top surface 120.

Similarly, with further reference to FIG. 6, the first mounting leg 24 flexes outwardly away from the second mounting leg 26 to accommodate the presence of the shelf 118. The shelf engagement portion 86 of the first mounting leg 24 forms an angle 130 with the main body structure 22 that is greater than the angle 94, illustrated in FIG. 3, formed between the shelf engagement portion 86 and the main body structure 22 when the sign holder 20 is not attached to a display apparatus. When the first mounting leg 24 is flexed to allow for accommodation of the shelf 118, due to the flexibly resilient nature of the first mounting leg 24 generally and the flexibly resilient nature of the curved portion 84, flange 82 and connection with the main body structure 22 specifically, the first mounting leg 24 is urged towards the bottom surface 122 of the shelf 118 to create pressure against the bottom surface 122 allowing the first mounting leg 24 to hold against the bottom surface 122. As illustrated in FIG. 6, the fingers 88 of the first mounting leg 24 contact the bottom surface 122 of the shelf 118 and tend to flex inwardly towards the main body structure 22. The fingers 53 can provide contact and grip with the bottom surface 122, as well as accommodate surface variations in the top surface 120.

Thus, in one embodiment, as illustrated in FIG. 6, the shelf 118 is essentially pinched between the flexibly resilient first and second mounting legs 24, 26 such that the sign holder 20 is held to the shelf 118. As will be understood by one having ordinary skill in the art, the sign holder 20 may be attached to shelves or other display apparatuses having various dimensions, with two mechanisms for the sign holder 20 to accommodate various size differences in display apparatuses: the first and second mounting legs 24, 26 may flex outwardly from one another various amounts to accommodate display apparatuses having different dimensions; and the second mounting leg 26 may be mounted to different mounting leg receiving structures on the main body structure 22, e.g., the various mounting posts 40, 42, 44 located different distances from the first mounting leg 24.

Embodiments of the sign holder 20 may be formed from any suitable material by any suitable method known in the art. In one embodiment, the sign holder 20 is extruded plastic, such as polyvinyl chloride, co-extruded polyvinyl chloride, butryrate, provista, acrylonitrile butadiene styrene or any other suitable material. In one embodiment, the sign holder is formed from hard vinyl material, except for the fingers, which are formed from soft vinyl material, with both being formed in a plastic extrusion.

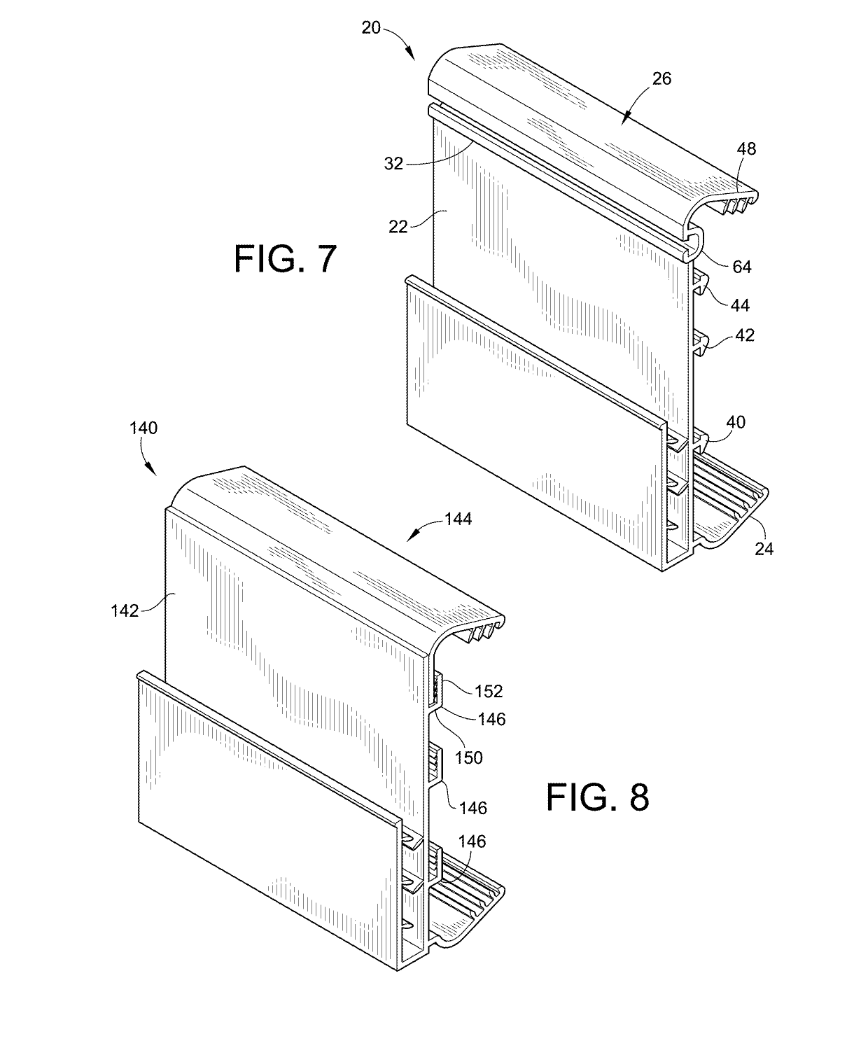

With reference to FIG. 7, one embodiment of the sign holder 20 is extruded with the second mounting leg 26, the main body structure 22, and the first mounting leg 24 formed as a single, unitary piece in a single extrusion. Upon extrusion, the portion of the C-shaped wall 64 distal from the shelf engagement portion 48 is attached to and extends from the first end 32 of the main body structure 22. In one embodiment, the sign holder 20 may be shipped to a user with the sign holder 20 in a single piece. In an embodiment with the sign holder 20 being formed as a single piece the second mounting leg 26 would already paired with main body structure 22 for packaging and shipping.

Thus, separate main body structure 22 and second mounting leg 26 pieces need not be paired up or sorted prior to packaging. Upon arrival to a user, the user may remove the second mounting leg 26 from the main body structure 22 by any suitable method known in the art and position the second mounting leg 26 relative to the main body structure 22 by attaching the second mounting leg 26 for example, in one embodiment, to one of the mounting posts 40, 42, 44 to locate the second mounting leg 26 relative to the first mounting leg 24 to distance the second mounting leg 26 an appropriate distance from the first mounting 24 for the display apparatus to which the sign holder 20 will be attached, as described above.

Additionally, it is also noted that after the sign holder 20 is attached to a display apparatus, it may later be removed from the display apparatus, and the second mounting leg 26 may be removed from a mounting post 40, 42, 44 and reattached to another of the mounting posts 40, 42, 44 such that the second mounting leg 26 may be relocated to a different distance from the first mounting leg 24 to accommodate mounting of the sign holder 20 to a display apparatus of a different size. In another embodiment, the second mounting leg 26 may be formed as a separate piece from the main body structure 22, for example, as a separate second extrusion.

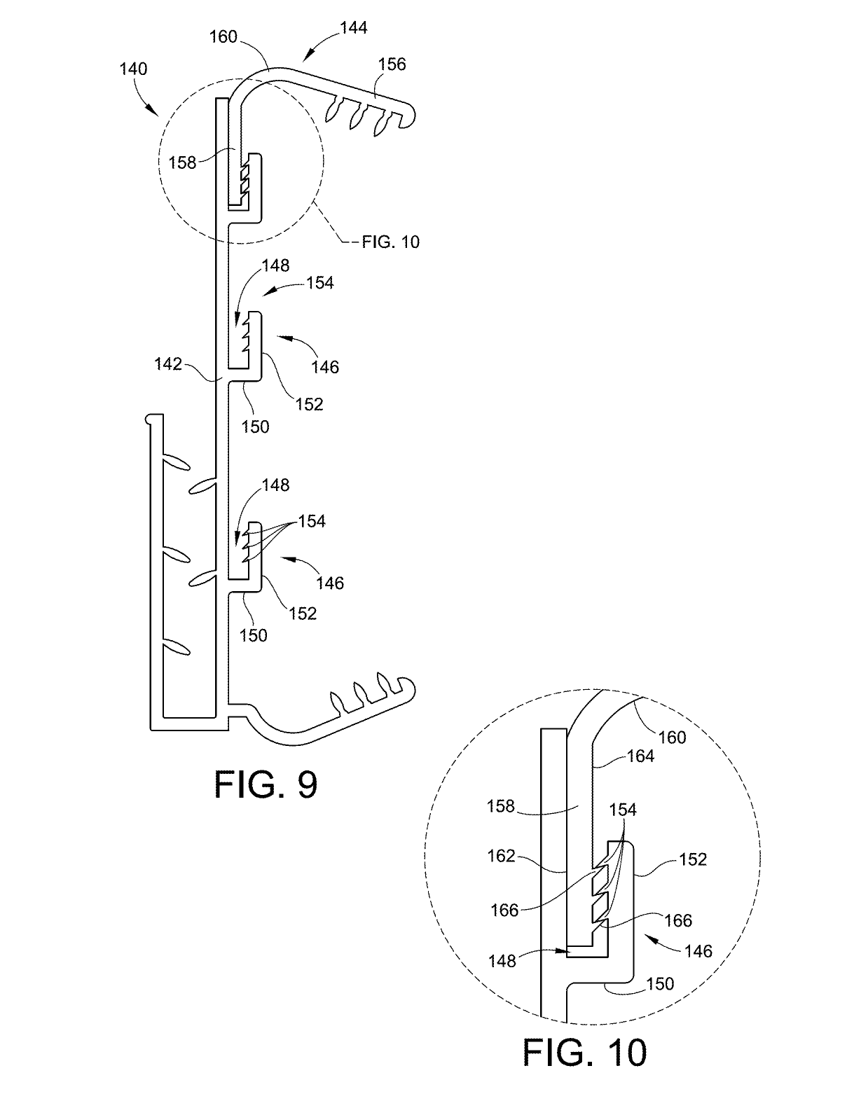

With reference to FIG. 8, a second embodiment of a sign holder 140 is illustrated. The second embodiment of the sign holder 140 includes many similarities to the first embodiment of the sign holder 20, however, various differences are described. As may best be seen in FIG. 9, the sign holder 140 includes a main body structure 142 and a second mounting leg 144. The main body structure 142 includes a plurality of locations for receiving the second mounting leg 144, in this embodiment, a plurality of L-shaped portions 146 defining receiving slots 148. The L-shaped portions 146 include horizontal flanges 150 extending from the main body structure 142 to vertical flanges 152 which extend upwardly from the horizontal flanges 150 generally parallel with the main body structure 142. The main body structure 142, the horizontal flanges 150, and the vertical flanges 152 define the receiving slots 148. With reference to FIG. 10, on the side of the vertical flanges 152 facing the main body structure 142, the vertical flanges 152 include an array of barbs 154 extending from the vertical flanges 152 towards the main body structure 142.

With further reference to FIG. 9, the sign holder 140 includes a second mounting leg 144. The second mounting leg 144 includes a shelf engagement portion 156 and a vertical main body structure engagement portion 158 connected to the shelf engagement portion 156 by a curved portion 160. As may best be seen in FIG. 10, the vertical main body structure engagement portion 158 includes a main body structure facing side 162 and a vertical flange facing side 164. The vertical flange facing side 164 includes an array of barbs 166 configured to engage the array of barbs 154 on the vertical flanges 154 to selectively secure the vertical main body structure engagement portion 158 within one of the receiving slots 148 and thus securing the second mounting leg 144 to the main body structure 142. As in the previous embodiment, the second mounting leg 144 can be moved between the receiving slots to accommodate mounting of the sign holder 140 on different size display apparatuses. The second mounting leg 144 may be inserted into the receiving slots 148 in any suitable manner, including those disclosed with respect to the first embodiment described above. As with the embodiment above, the number and spacing of receiving slots 148 is purely exemplary, and various other numbers and configurations of spacing are envisioned.

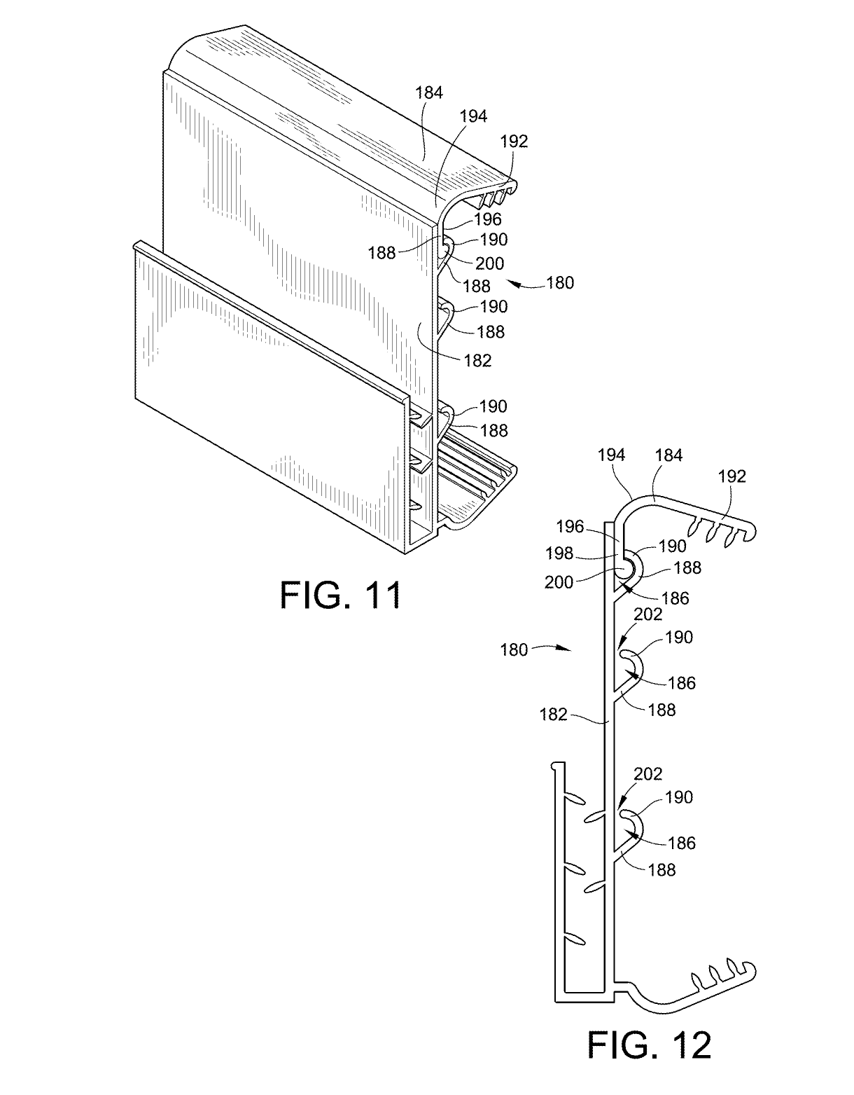

With reference to FIG. 11, a third embodiment of a sign holder 180 is illustrated. The third embodiment of the sign holder 180 includes many similarities to the first embodiment of the sign holder 20, however, various differences are described. As may best be seen in FIG. 12, the sign holder 180 includes a main body structure 182 and a second mounting leg 184. The main body structure 182 includes a plurality of locations for receiving the second mounting leg 184, in this embodiment, a plurality of radial slots 186. The radial slots 186 are each defined by an angular portion 188 extending angularly away from the main body structure 182 to a hooked portion 190 hooking back towards the main body structure 182.

The second mounting leg 184 includes a shelf engagement portion 192 extending into a curved portion 194 which connects the shelf engagement portion 192 with a main body structure engagement portion 196. The main body structure engagement portion 196 includes a vertical flange 198 extending generally parallel with the main body structure 182 when engaged with the main body structure 182. The vertical flange 198 terminates in a bulb structure 200 which is rounded and has a radius greater than the thickness of the vertical flange 198. In engagement with the main body structure 182 the bulb structure 200 is placed in one of the radial slots 186 with the hooked portion 190 extending around and above the bulb structure 200 of the second mounting leg 184. Because the gap 202 between the end of the hooked portion 190 and the main body structure 182 is smaller than the radius of the bulb structure 200 of the second mounting leg 184, the second mounting leg 184 is releasably held to the main body structure 182. The bulb structure 200 may be slidably displaced from the side into the radial slots 186 or may be snapped into place, as described above with respect to the first embodiment. In one embodiment the hooked portion 190 and the angular portion 188 are flexibly resilient, allowing the gap 202 to be temporarily increased in size with the flexing away from the main body structure 182 of the hooked portion 190 and the angular portion 188 to allow the bulb structure 200 to enter the radial slots 186. As with the embodiments above, the second mounting leg 184 may be removably placed within any of the radial slots 186 to allow for adjustment and coupling to display apparatuses of various sizes. As with the embodiment above, the number and spacing of receiving slots 148 is purely exemplary, and various other numbers and configurations of spacing are envisioned.

It should be noted that while three exemplary embodiments of possible selectively releasable coupling structures between a second mounting leg and a main body structure are illustrated, that these are only exemplary and illustrative, and the present invention is in no way limited to these embodiments. Various other coupling structures allowing for selective adjustment of mounting legs relative to one another and attachment of a sign holder to display apparatuses of various sizes are envisioned.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sign holder comprising:
a main body structure including a sign receiving structure and a plurality of second mounting leg receiving structures;
a first mounting leg extending from the main body structure;
a second mounting leg selectively mountable with a select one of the second mounting leg receiving structures.
wherein the second mounting leg is selectively removable from the main body structure.

2. The sign holder of claim 1, wherein the first mounting leg includes a display apparatus engagement portion; and
wherein the display apparatus engagement portion of the first mounting leg forms an acute angle with the main body structure when the sign holder is not engaged with a display apparatus.

3. The sign holder of claim 2, wherein the second mounting leg includes a display apparatus engagement portion and a main body structure engagement portion, the main body structure engagement portion being selectively mountable to each of the plurality of second mounting leg receiving structures; and
wherein each of the second mounting leg receiving structures locates the display apparatus engagement portion of the second mounting leg a different distance from the display apparatus engagement portion of the first mounting leg.

4. The sign holder of claim 3, wherein at least one of the display apparatus engagement portion of the first mounting leg and the display apparatus engagement portion of the second mounting leg includes at least one flexible finger formed of a different material than the other portions of the first and second mounting legs and displaceable towards the one of the display apparatus engagement portion of the first mounting leg and the second mounting leg to accommodate display apparatuses of various sizes.

5. The sign holder of claim 3, wherein the display apparatus engagement portions of the first and second mounting legs are configured to flex away from one another when engaging a display apparatus and to increase the angle between the first mounting leg and the main body structure and the angle between the second mounting leg and the main body structure.

6. The sign holder of claim 3, wherein the main body structure engagement portion of the second mounting leg may be at least one of slid and snapped into engagement with each of the second mounting leg receiving structures.

7. The sign holder of claim 1, wherein the second mounting leg is formed with the main body structure as a single unitary piece.

8. The sign holder of claim 1, wherein the sign holder is constructed as at least one of co-extruded polyvinyl chloride, butryrate, provista, and acrylonitrile butadiene styrene.

9. The sign holder of claim 1, wherein the sign receiving structure comprises a channel with at least one flexible finger extending into the channel.

10. The sign holder of claim 1, wherein when the second mounting leg is engaged with one of the second mounting leg receiving structures and the sign holder is mounted on a display apparatus, the second mounting leg contacts the main body structure proximate the one of the second mounting leg receiving structures to bias the second mounting leg to hold against the display apparatus.

11. A sign holder comprising:
a main body structure;
a flexible first mounting leg having a base and a distal end portion extending from the base, the base extending from the main body structure; and
a flexible second mounting leg having a main body structure engagement portion and a distal end portion extending from the main body structure engagement portion, the main body structure engagement portion being positionable at various locations on the main body structure relative to the first mounting leg;
the first mounting leg, the second mounting leg, and the main body structure forming a display apparatus receiving channel configured to receive an edge of a display apparatus; and
the distal end portions of the first and second mounting legs being displaceable relative to one another to vary the size of the display apparatus receiving channel to receive display apparatuses of different dimensions.

12. The sign holder of claim 11, wherein the main body structure, the first mounting leg, and the second mounting leg are extruded as a single, unitary piece with the second mounting leg being detachable therefrom.

13. The sign holder of claim 11, wherein the main body structure further comprises a first second mounting leg receiving structure spaced apart a first distance from the first mounting leg and a second second mounting leg receiving structure spaced apart a second distance from the first mounting leg, the second mounting leg being selectively engagable with each of the mounting leg receiving structures to selectively vary the distance between the second mounting leg and the first mounting leg and a dimension of the display apparatus receiving channel.

14. The sign holder of claim 13, wherein the second mounting leg receiving structures each include a mounting post, wherein the second mounting leg includes a channel, and wherein the mounting post is received in the channel to selectively releasably couple the second mounting leg to the main body structure.

15. The sign holder of claim 13, wherein the second mounting leg receiving structures each define a channel, wherein the second mounting leg includes a projection, and wherein the projection is received in the channel to selectively releasably couple the second mounting leg to the main body structure.

16. The sign holder of claim 11, wherein the main body structure includes a sign receiving channel configured to support signs of various dimensions.

17. The sign holder of claim 11, wherein the first and second mounting legs are resiliently biased towards one another, with the first mounting leg configured to exert a force on a first surface of a display apparatus and the second mounting leg configured to exert a force on a second surface of a display apparatus, thereby pinching the display apparatus between the first and second mounting legs and mounting the main body structure to the display apparatus.

18. A sign holder, comprising:
a main body structure having a plurality of mounting structures;
a flexible first mounting leg extending outwardly from the main body structure;
a flexible second mounting leg selectively mountable with the main body structure on a select one of the plurality of mounting structures; and
wherein the main body structure, the first mounting leg, and second mounting leg define a variable width channel, a width of the variable width channel being set by the distance between the first and second mounting legs when the second mounting leg is mounted on the select one of the plurality of legs.

19. A display apparatus comprising:
a shelf having a front surface, a top surface, and a bottom surface;
a sign holder including a main body structure, a first leg, and a second leg, together defining a shelf receiving channel;
the second leg being repositionable relative to the first leg and the main body structure, thereby adjusting the size of the shelf receiving channel to accommodate the shelf;
the first leg being biased against one of the top surface and the bottom surface of the shelf, the second leg being biased against the other of the top surface and the bottom surface of the shelf, thereby holding the sign holder to the shelf; and
the main body structure including a sign supporting structure.
